(19) United States
(12) Patent Application Publication
(10) Pub. No.: US 2004/0203803 A1
(43) Pub. Date: Oct. 14, 2004

(54) Delivery policy tool

(76) Inventor: Scott P. Taylor, Renton, WA (US)

Correspondence Address: HARNESS, DICKEY & PIERCE, P.L.C., P.O. BOX 828, BLOOMFIELD HILLS, MI, 48303, US

(21) Appl. No.: 10/393,051

(22) Filed: Mar. 20, 2003

Related U.S. Application Data
(63) Continuation-in-part of application No. 09/992,150, filed on Nov. 6, 2001.

(51) Int. Cl. H04M 3/42

(52) U.S. Cl. 455/445; 455/512; 455/414.1

(57) ABSTRACT

A system and method are provided that enable a bi-directional mobile communication system to prioritize the delivery of content to mobile platforms based input from a policy algorithm. The policy algorithm is in communication with a database that contains rules for distribution of content (e.g., Internet web pages, audio, and video, among others). The policy algorithm is further in communication with a link management system that provides information as to which mobile platforms are available and a plurality of routers to improve bandwidth utilization. Accordingly, the system according to the present invention prioritizes deliveries and updates of content to the mobile platform in a timely and cost-efficient manner.

### FIELD OF THE INVENTION

The present invention relates generally to mobile communication systems and more particularly to systems and methods for controlling the distribution of data to mobile platforms such as commercial aircraft.

### BACKGROUND OF THE INVENTION

Broadband data and video services have previously been unavailable to users onboard mobile platforms such as aircraft, ships, trains, automobiles, and other modes of mass transportation. While the technology is available to deliver such services to various forms of mobile platforms, past solutions have been generally expensive, of a low data rate, and/or available only to limited markets of government or military users and a few high-end maritime markets (e.g., cruise ships).

Previously developed systems that have attempted to provide data services to mobile platforms have done so with only limited success. One major obstacle has been the high cost of access to broadband data services, along with the limited capacity of previously developed systems, which is insufficient for a plurality of mobile platforms collectively carrying hundreds, or even thousands, of individuals who each may be simultaneously requesting different data services. Furthermore, existing mobile communications systems are generally not readily scalable to address the demands of the traveling public.

Current mobile platform connection methods are inherently narrow band and restrict the flow of data to the point where common networking tasks are impossible. Typically, such connectivity is achieved through the use of a standard computer telephone modem between the computer of the user and the air-ground or ship-shore telephony system. In such a system, each user obtains exclusive use of a full communications channel for the duration of his/her networking session and effectively prevents others from using that portion of the telephony system.

Another known mobile communication service generally provides pre-stored worldwide web content to users on a mobile platform. The service is anticipated to incorporate a server located on a mobile platform to provide its stored content to users on the mobile platform through a simple touch screen interface. The content located on the server would be updated once every few weeks while the mobile platform is in an inactive mode, such as when an aircraft is parked at an airport gate or a ship is docked at a port. The update of the data on the mobile platform would be accomplished through the loading of CD ROMs (Compact Disc Read Only Memory) or swapping of hard drives on the server. Although the content stored on the mobile platform with such a service may be varied, it will never be timely and up to date.

In view of the foregoing, a significant need exists to provide a system and method for providing live and up to date data communication to users onboard mobile platforms. More specifically, a need exists to provide Internet data communications, (e.g., web page content delivery), video data services, and audio data services, among others, in a prioritized and timely fashion to a variety of users onboard a plurality of mobile platforms.

### SUMMARY OF THE INVENTION

In one preferred form, the present invention provides a system for distributing content to mobile platforms that generally comprises a database containing rules for distribution of the content and a policy algorithm in communication with a database whose output is transmitted to a content delivery system to control distribution of content to the mobile platforms. Accordingly, deliveries and updates to content for mobile platforms such as Internet web page content, video files, and audio files to an on-board server or storage device is scheduled and prioritized by the system of the present invention. For example, the rules stored in a database for the policy algorithm may prioritize one set of users over another one type of content over another (type being file size, etc.) or vary web page updates to suit the needs of a particular user such as a commercial airline or cruise ship.

The policy algorithm is further in communication with a link management system that provides information regarding available and location of mobile platforms, that are currently using the broadband system that are requiring content delivery. Additionally, the policy algorithm is in communication with a plurality of network element buffers (router buffers) that correspond to satellite transponders in the various satellite coverage regions through the world that are the final stage of delivery to get the content to the mobile platform. The buffers provide bandwidth utilization and available capacity to the policy algorithm to optimize the delivery of content or to indicate when sufficient capacity is available. Generally, the buffers are monitored by the policy algorithm to determine the percent loading on each transponder and thus how content is to be efficiently distributed to the mobile platforms.

The database and the policy algorithm are preferably located within a ground control station that communicates with the mobile platforms via satellite communications as described in co-pending application Ser. No. 09/639,912 entitled “Method and Apparatus For Providing Bi-Directional Data Services and Live Television Programming to Mobile Platforms,” filed on Aug. 16, 2000, which is assigned to the assignee of the present application and is hereby incorporated by reference in its entirety.

In another preferred form, a method of distributing content to a mobile platform is provided, wherein the content is prioritized and delivered to a variety of users onboard a plurality of mobile platforms based in part on execution of rules by the policy algorithm. In this method, the content is multicast to a number of mobile platforms all at once. Each mobile platform shares a unique set of multicast addresses (special Internet addresses) based on the content scheduled for delivery. An acknowledgement (positive or negative) is associated with each delivery to validate that the available mobile platforms that were scheduled to receive content did indeed receive it. The content is delivered according to the rules captured within the database that the policy algorithm uses and the priority of delivery selectable by the customer (for example, selectable through a web interface).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a system for distributing content to a mobile platform.

### DETAILED DESCRIPTION OF THE PREFERRED EMBODIMENT

The following description of the preferred embodiments is merely exemplary in nature and is in no way intended to limit the invention, its application, or uses.

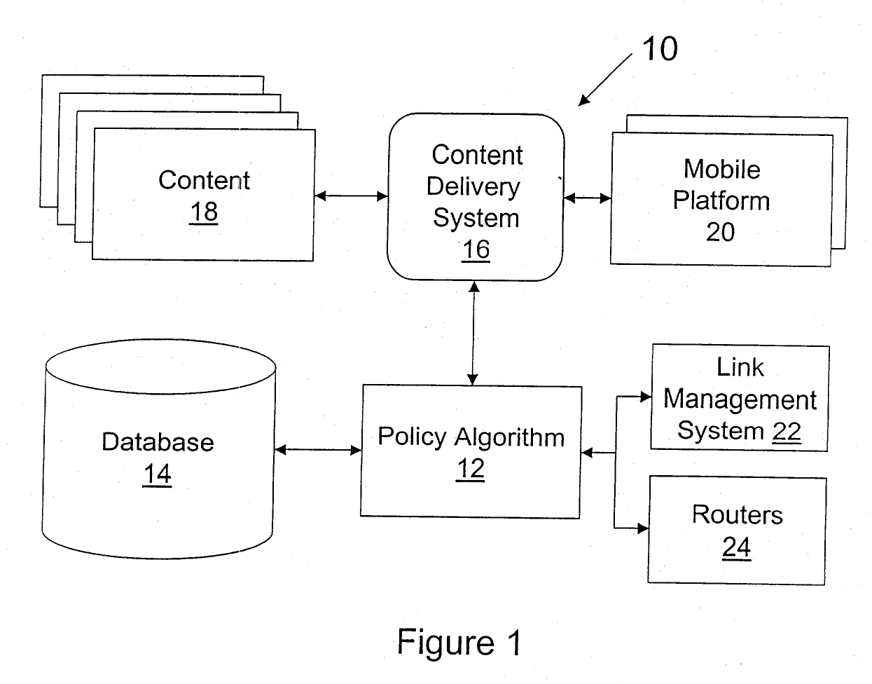

Referring to the drawings, a system for distributing content to a mobile platform according to the present invention is illustrated and generally indicated by reference numeral 10 in FIG. 1. As shown, the system 10 comprises a policy algorithm 12 in communication with a database 14 and a content delivery system 16, wherein the content delivery system 16 manages and controls delivery of content 18 to a mobile platform 20, or a plurality thereof.

Although the detailed description herein is directed to an in-flight system delivering content to passengers on commercial aircraft, the invention is also applicable to other modes of mass transit such as ship, train, bus, and others, and the reference to aircraft should not be construed as limiting the scope of the present invention. Further, the term “content” as used herein is intended to include communications data such as Internet web content, audio data such as in-flight music or boarding messages, video data such as in-flight entertainment, or cellular data, among others.

The policy algorithm 12 is executed in part based on a set of rules within the database 14 for distribution of the content 18. For example, the rules may prioritize one set of users over another such as first class passengers over coach or one airline over another, or may vary web page update rates to suit the needs of a particular user or set of users. Further, the rules may establish specific mobile platforms as having priority for a particular type of content. Accordingly, the content delivery system 16 delivers content that has been prioritized by the policy algorithm 12 to the mobile platform 20 based on a flexible set of rules within the database 14, which results in more efficient delivery of data to a plurality of mobile platforms 20.

As further shown, the policy algorithm 12 is in communication with a link management system 22. The link management system 22 provides information as to which mobile platforms 20 are available to receive content 18. Accordingly, the policy algorithm 12 utilizes such information, along with the rules within the database 14, in order to prioritize delivery of the content 18 to the content delivery system 16. For example, the database 14 may contain a rule that an aircraft having a certain tail number requires only certain types of content 18. Further, the policy algorithm 12 may be executed such that certain aircraft tail numbers that require a particular type of content, e.g. specific Internet web sites, are given top priority. Therefore, any number and combination of rules within the database 14 and priorities within the policy algorithm 12 may be employed to control distribution of content 18 to the mobile platform 20 according to specific application requirements.

As further illustrated, the policy algorithm 12 is also in communication with a plurality of routers 24. Generally, the routers 24 distribute data that is being transmitted through various RF (radio frequency) links to satellites that communicate with ground control stations. In operation, the policy algorithm 12 monitors the routers 24 to determine the loading on each buffer, and the policy algorithm 12 may then execute priorities according to such loadings. For example, content 18 may only be redistributed to the content delivery system 16 if the buffers are at 50% or less of their capacity. As a result, improvements in bandwidth utilization may be realized to facilitate efficient delivery of content 18 to the mobile platform 20.

Accordingly, a system and method for distributing content to a mobile platform is provided, wherein content is delivered to a plurality of mobile platforms in a prioritized order based on a number of inputs from, for example, rules within a database, a link management system, and a plurality of routers. As a result, content is delivered to users onboard mobile platforms in a timely and cost-efficient manner.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A system for distributing content to a mobile platform comprising:
a database containing rules for distribution of the content;
a policy algorithm in communication with the database; and
a content delivery system,
wherein the policy algorithm is executed to communicate the rules from the database to the content delivery system to control distribution of the content to the mobile platform.

2. The system of claim 1 further comprising a link management system in communication with the policy algorithm, wherein the link management system provides the policy algorithm with available mobile platforms.

3. The system of claim 1 further comprising a plurality of buffers in communication with the policy algorithm to provide bandwidth utilization.

4. The system of claim 1, wherein the database and policy algorithm are located within a ground control station in communication with the mobile platform.

5. The system of claim 4, wherein the ground control station is in communication with the mobile platform via satellite communication.

6. The system of claim 1, wherein the content comprises Internet web pages.

7. The system of claim 1, wherein the content comprises audio data.

8. The system of claim 1, wherein the content comprises video data.

9. The system of claim 1, wherein the policy algorithm is stored in the database.

10. A system for distributing content to a mobile platform comprising:
a database containing rules for distribution of the content;
a policy algorithm in communication with the database;
a link management system in communication with the policy algorithm, wherein the link management system provides the policy algorithm with available mobile platforms;
a plurality of buffers in communication with the policy algorithm to provide bandwidth utilization; and
a content delivery system,
wherein the policy algorithm is executed to communicate the rules from the database to the content delivery system to control distribution of the content to the mobile platform.

11. The system of claim 10, wherein the database and policy algorithm are located within a ground control station in communication with the mobile platform.

12. The system of claim 11, wherein the ground control station is in communication with the mobile platform via satellite communication.

13. The system of claim 10, wherein the content comprises Internet web pages.

14. The system of claim 10, wherein the content comprises audio data.

15. The system of claim 10, wherein the content comprises video data.

16. A method of distributing content to a mobile platform comprising the steps of:
(a) executing a policy algorithm in communication with a database having rules for distribution of the content;
(b) transmitting output from the policy algorithm to a content delivery system; and
(c) distributing content to the mobile platform based on the rules within the database.

17. The method of claim 16 further comprising the step of providing available mobile platforms from a link management system to the policy algorithm

18. The method of claim 16 further comprising the step of monitoring loading on a plurality of buffers to provide bandwidth utilization.
